(19) United States
(12) Patent Application Publication
(10) Pub. No.: US 2018/0185991 A1
(43) Pub. Date: Jul. 5, 2018

(54) DUAL HEAD RATCHET AND SOCKET WRENCH ASSEMBLY

(71) Applicant: DENNIS NAUMANN, HUDSON, FL (US)

(72) Inventor: DENNIS NAUMANN, HUDSON, FL (US)

(21) Appl. No.: 15/396,472

(22) Filed: Dec. 31, 2016

(51) Int. Cl. B25B 13/48; B25B 13/46; B25B 23/00

(52) U.S. Cl. CPC B25B 13/481; B25B 23/0035; B25B 13/467

(57) ABSTRACT

A dual head ratchet and socket wrench assembly having an L-shaped rigid housing to accommodate a first elongated shaft having a top end and a bottom end and a second elongated shaft having a left end and a right end. The top end of the first elongated shaft is configured to removably attach with a female connector including a socket and right end of the second elongated shaft is configured to attach with a male connector including a ratchet. A pair of gears operably connects the bottom end of the first elongated shaft and the left end of the second elongated shaft within the L-shaped rigid housing. The first elongated shaft and the second elongated shaft are operably positioned within a hollow interior of the L-shaped rigid housing to operate on a number of mechanical connecting means positioned at tight areas and around narrow corners.

### BACKGROUND OF THE INVENTION

### Technical Field of the Invention

The present invention relates to a wrench tool. More specifically, the present invention relates to a dual head wrench tool having a ratchet and a socket wrench end.

### Description of the Related Art

Many types of socket wrenches are known in the art. The most prevalent form is the ratcheting socket wrench, often called a ratchet. A socket wrench is a type of wrench that has a socket attached at one end, usually used to turn a fastener. A ratchet is a hand tool in which a metal handle is attached to a ratcheting mechanism, which attaches to a socket, which in turn fits onto a type of bolt or nut. The ratchet loosens or tightens the bolt or nut attached to the socket when pulled or pushed in one direction. When the ratchet is turned in the other direction, the ratchet does not turn the socket but allows the ratchet handle to be re-positioned for another turn while staying attached to the bolt or nut. This ratcheting action allows the fastener to be rapidly tightened or loosened in small increments without disconnecting the tool from the fastener. A switch is built into the ratchet head that allows the user to apply the ratcheting action in either direction, as needed, to tighten or loosen a fastener.

Many types of ratchet wrenches are available in the market. Conventional wrenches typically include a wrench body, a torque receiving gear having gear teeth, a switch member and a gear-engaging member in the form of a pawl having engaging teeth for intermeshing with the teeth on the torque receiving gear. Typically, the switch member in a conventional ratchet wrench is selectively movable between two positions. In each of these two positions, the pawl is engaged with the gear teeth such that the wrench in one direction rotates the gear to apply torque to a fastener and rotating the wrench in the opposite direction causes the pawl to ride over the gear teeth in a ratcheting manner. A conventional wrench device with a pivoting tool head includes a locking member disposed between a handle and a tool head and is controlled by a controller to come close to or keep away from the tool head. The controller is provided with a pushing portion and a retracting portion, and an elastic positioning assembly serves to fix the controller, such that the controller can be fixed after being pulled by the user. In addition, the pushing portion or the retracting portion of the controller is aligned with the locking member, so that the locking member will contact the tool head so as to fix the tool head, or will not contact the tool head so as to make the tool head swing, thus providing a quick positioning structure and improving the stability of the products, such that the user operates the conventional wrench device with a pivoting tool head in the working place with a small spatial size.

Many prior patents disclose various types of ratchet wrenches. A typical example of such a ratchet wrenches are found in the following patents, which are herein incorporated by reference for their supportive teachings, as follows:

U.S. Pat. No. 5,533,427 A discloses a ratchet wrench with an arcuate pawl. The arcuate shape of the pawl enables most or all of the teeth to be engaged with the gear teeth. The pawl is pivotally mounted on the upright free end of a torsion spring. The spring biases the pawl into engagement with the gear so as to provide a ratcheting action on the wrench's return stroke. As the switch is moved between positions, the upright free end of the torsion spring swings and moves the pawl to its opposite position for reverse driving. One drawback of this design, however, is that if the pawl is slightly stuck or jammed, movement of the switch may simply deflect the spring without moving the pawl. In addition, the ratchet wrench cannot be used for operating on tight or narrow areas and around corners with a small amount of space.

U.S. Pat. No. 8,943,930 B2 issued to Chao-Chih Liu discloses a wrench device that includes a handle, a driving member and a driving sleeve. The handle includes a fork portion defined at one end, which is pivotally assembled with the driving member. The handle further includes a screwing portion with a screwing hole defined at another end. An opening of the screwing hole is positioned opposite to the fork portion and the driving sleeve is on an outer periphery of the screwing portion. Under this arrangement, a user applies a sleeving member to sleeve on the driving member so as to screw or unscrew a bolt. In addition, the user also can operate the screwing portion of the wrench device to screw or unscrew the bolt. However, the ratchet wrench cannot be used for operating on tight or narrow areas and around corners with a small amount of space.

U.S. Pat. No. 7,155,998 B1 issued to Wen-Tsai Shyu discloses a T-shaped ratchet wrench having a main body and a force-applying auxiliary arm. The main body includes a cross shaft and a working shaft. A ratchet driving mechanism having a change-over selector is disposed within an intersection position of both shafts. Each end of the cross shaft having an annular groove, and the working shaft has a polygonal head for inserting into a sleeve. The working shaft includes an annular groove in close vicinity to the cross shaft. The force-applying auxiliary arm includes an internal hole for mounting on either end of the working shaft or the cross shaft of the main body. The force-applying auxiliary arm has one end with an engaging socket and another end with a handle portion. The T-shaped ratchet is designed to prevent bending and cracking of the working shaft due to exposure to an unexpected impact. However, the T-shaped ratchet wrench cannot be used for operating on tight or narrow areas and around corners with a small amount of space.

Hence, it can be seen that there is a need for an improved ratchet wrench, which can be easily used by the users to operate on tight or narrow areas and around corners with a small amount of space. Moreover, the needed ratchet wrench would enable the users to connect a number of sockets and other mechanical extensions of different sizes. Further the needed ratchet wrench would assist the users to efficiently utilize their effort by providing necessary torque to the user while in use.

### SUMMARY OF THE INVENTION

In view of the foregoing disadvantages inherent in the known types of wrench tools like in the prior art, the present invention provides a dual head ratchet and socket wrench assembly useful for operating on a number of mechanical connecting means. The present dual head ratchet and socket wrench assembly includes an L-shaped rigid housing having a hollow interior housing a first elongated shaft having a top end and a bottom end and a second elongated shaft having a left end and a right end. The top end of the first elongated shaft is configured to attach with a female connector such as a socket. The right end of the second elongated shaft is configured to attach with a male connector such as a ratchet extending out from the right end of the L-shaped rigid housing. A pair of gears operably connects the bottom end of the first elongated shaft and the left end of the second elongated shaft. The present dual head ratchet and socket wrench assembly is specially designed for operating on the mechanical connecting means at tight or narrow areas and around corners with a small amount of space to work with.

Accordingly, it is an object of the present invention is to provide a dual head ratchet and socket wrench assembly having a male connector and female connector to operate on a number of mechanical connecting means.

Yet another objective of the present invention is to provide a dual head ratchet and socket wrench assembly having a female connector in form of a socket and a male connector in form of a ratchet.

Yet another objective of the present invention is to provide a dual head ratchet and socket wrench assembly having a female connector and male connector both configured to detachably connect with a number external sockets having different sizes.

Another objective of the present invention is to provide a dual head ratchet and socket wrench assembly having a male connector configured to detachably receive a number of external mechanical tools, mechanical tool extensions and sockets.

Yet another objective of the present invention is to provide a dual head ratchet and socket wrench assembly having an L-shaped housing with detachable sockets on both ends.

Another objective of the present invention is to provide a dual head ratchet and socket wrench assembly having a pair of elongated shafts arranged in an L-shape.

Yet another objective of the present invention is to provide a dual head ratchet and socket wrench assembly capable of operating on tight or narrow areas and around corners with a small amount of space.

Yet another objective of the present invention is to provide a dual head ratchet and socket wrench assembly having an L-shaped housing for enabling the users to efficiently utilize their effort by providing necessary torque to the user while in use.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention.

Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 is a front perspective view of a dual head ratchet and socket wrench assembly useful for operating on a number of mechanical connecting means, according to a preferred embodiment of the present invention; and

FIG. 2 illustrates a front perspective view of the dual head ratchet and socket wrench assembly showing arrangements of a number of internal parts, according to a preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiment of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

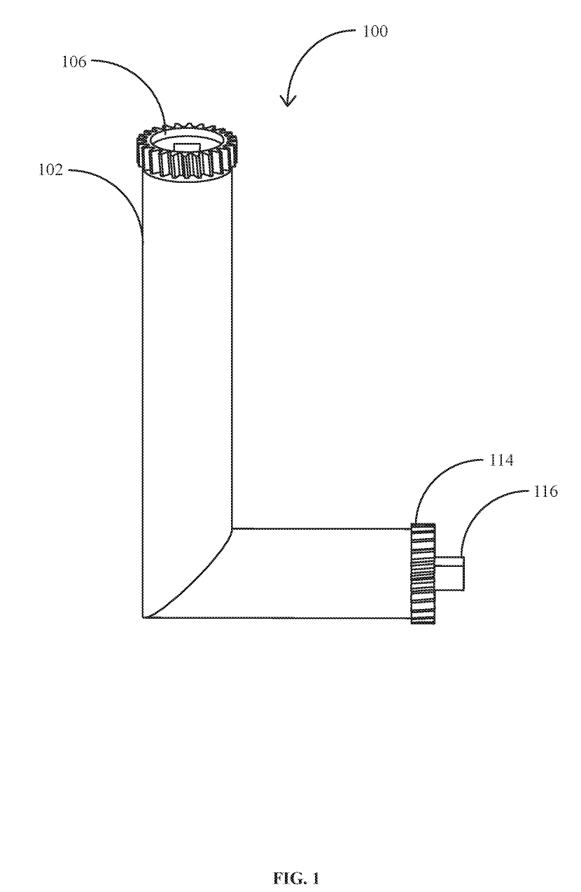

FIG. 1 is a front perspective view of a dual head ratchet and socket wrench assembly 100 useful for operating on a number of mechanical connecting means, according to a preferred embodiment of the present invention. The present dual head ratchet and socket wrench assembly 100 is designed to substantially reduce the difficulty during the removal or tightening of nuts, bolts or any other mechanical attachments means through tight or narrow areas and around corners with a small amount of space to work with. The present dual head ratchet and socket wrench assembly 100 includes an L-shaped rigid housing 102 having a hollow interior. According to a preferred embodiment, connecting a pair of hollow rigid tubes at right angle makes the L-shaped rigid housing 102. The hollow rigid tubes of the L-shaped rigid housing 102 are formed from rigid materials including metals, alloys, plastic, rubber and a combination of any of these materials. In some instances, the external surface of the L-shaped rigid housing 102 are coated with materials such as rubber and are contoured for providing proper grip to the user while in use. The L-shaped rigid housing 102 of the dual head ratchet and socket wrench assembly 100 houses a first elongated shaft 104 having a top end 106 and a bottom end 108. The top end 106 of the first elongated shaft 104 is configured to attach with a female connector such as, but not limited to, a socket. The female connector such as the socket attached to the top end 106 of the first elongated shaft 104 is used for removing or connecting a mechanical attachment means such as, but not limited to, a mechanical fastener or nut or bolt. The top end 106 of the first elongated shaft 104 allows the users to attach any kind of female connector such as the socket of different sizes including hexagonal or 6-point sockets. The L-shaped rigid housing 102 of the dual head ratchet and socket wrench assembly 100 further houses a second elongated shaft 110 having a left end 112 and a right end 114. The right end 114 of the second elongated shaft 110 is configured to attach with a male connector 116 as shown in FIG. 1. According to a preferred embodiment, the male connector 116 provided on the right end 114 of the second elongated shaft 110 is a ratchet extending out from the L-shaped rigid housing 102. The ratchet can be used to attach with a number of mechanical tools, mechanical tool extensions and sockets, which can further be employed for removing or connecting a mechanical attachment means such as, but not limited to, a mechanical fastener or nut or bolt. Further the bottom end 108 of the first elongated shaft 104 and the left end 112 of the second elongated shaft 110, each are attached with gears 118, 120 respectively, arranged to engage together to rotate the first elongated shaft 104 and the second elongated shaft 110 when in use. The pair of gears 118, 120 enables the first elongated shaft 104 and the second elongated shaft 110 to operably position within the L-shaped rigid housing 102 to connect, i.e. tighten or remove a variety of mechanical connecting means including nuts and bolts.

The top end 106 of the first elongated shaft 104 can be provided with different size sockets such as, but not limited to ¼ inch, ⅜ inch, ½ inch, ¾ inch drives, etc. to properly engage with nuts and bolts of different sizes. The teeth arrangement on the socket can be varied depending on the requirement and the type of socket required for a particular application. The sockets or the female connectors are removably attached to the top end 106 of the first elongated shaft 104 using mechanical fixing including screws or any other mechanical fixing means, without actually disrupting the rotation of the first elongated shaft 104 and the associated second elongated shaft 110 when in use. Similarly, the male connector 116 or the ratchet provided on the right end 114 of the second elongated shaft 110 is removably attached to the right end 114 of the second elongated shaft 110 using mechanical fixing means including screws or any other mechanical fixing means, without actually disrupting the rotation of the second elongated shaft 110 and the associated first elongated shaft 104 when in use. The pair of gears 118, 120 are operably attached to the bottom end 108 of the first elongated shaft 104 and the left end 112 of the second elongated shaft 110, respectively, using screws or any one mechanical fixing means. The L-shaped rigid housing 102 of the dual head ratchet and socket wrench assembly 100 includes a pair of access doors (not shown) at a corner area near the pair of gears 118, 120 attached to the bottom end 108 of the first elongated shaft 104 and the left end 112 of the second elongated shaft 110, respectively. The access doors enable the users to do proper maintenance of the pair of gears 118, 120 during use. Further the male connector 116 or the ratchet of various sizes, such as, but not limited to, ¼ inch, ⅜ inch, ½ inch, ¾ inch, etc. can be removably attached to the right end 114 of the second elongated shaft 110. In some other embodiment, the male connector 116 provided at the right end 114 of the second elongated shaft 110 is configured to attach with external attachments including external mechanical tools, mechanical tool extensions, sockets, etc. Hence, a user can manually attach or remove the external attachments to the male connector 116 provided at the right end 114 of the second elongated shaft 110 based on the requirement.

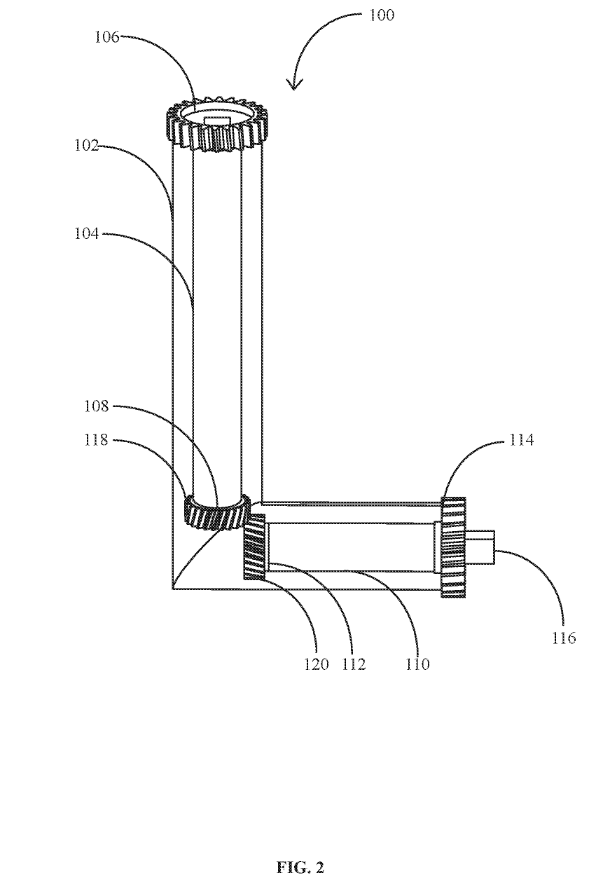

FIG. 2 illustrates a front perspective view of the dual head ratchet and socket wrench assembly 100 showing arrangements of a number of internal parts, according to a preferred embodiment of the present invention. The L-shaped rigid housing 102 allows the users to easily hold the dual head ratchet and socket wrench assembly 100 and also provides required torque to attach or remove the mechanical attachment means including the nut and bolts to a desired location. The dual head ratchet and socket wrench assembly 100 allows the user to efficiently utilize his/her effort by providing necessary torque to the user while in use. The male connector 116 provided on the right end 114 of the second elongated shaft 110 extends out from the L-shaped rigid housing 102 to attach with the external mechanical tools, extensions and other external sockets of different sizes. The present dual head ratchet and socket wrench assembly 100 can be modified and made available to the users in different sizes and for different type of applications. The L-shaped rigid housing 102 of the dual head ratchet and socket wrench assembly 100 can be formed from rigid materials including metals, alloys, plastic, rubber and a combination of any of these. Similarly the first elongated shaft 104 and the second elongated shaft 110 are made from solid metals or alloys having sufficient strength to perform the mechanical operations as discussed above. The L-shaped rigid housing 102 enables the users to extend the socket provided on the top end 106 of the first elongated shaft 104 and the ratchet provided on the right end 114 of the second elongated shaft 110 to reach into narrow corners and tight locations, where other existing tools cannot be used effectively. In an embodiment, the length of the first elongated shaft 104 is more than that of the second elongated shaft 110 so that the users can use the dual head ratchet and socket wrench assembly 100 conveniently at narrow corners and tight locations. This also provides enough torque to the user to operate on the mechanical connections in a variety of places such as, but not limited to, in a vehicle, machines and other tools.

Further, it should be noted that the steps described in the method of use can be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A dual head ratchet and socket wrench assembly, comprising:
an L-shaped rigid housing;
a first elongated shaft having a top end and a bottom end, the top end being configured to attach with a female connector;
a second elongated shaft having a left end and a right end, the right end being configured to attach with a male connector; and
a pair of gears operably connecting the bottom end of the first elongated shaft and the left end of the second elongated shaft;
characterized in that the first elongated shaft and the second elongated shaft are operably positioned within the L-shaped rigid housing to operate on a plurality of mechanical connecting parts.

2. The dual head ratchet and socket wrench assembly of claim 1, wherein the female connector provided on the top end of the first elongated shaft is a socket capable of engaging with the mechanical attachment parts, including nuts and bolts.

3. The dual head ratchet and socket wrench assembly of claim 1, wherein the top end of the first elongated shaft allows removable attachment of a plurality of external sockets having a plurality of sizes.

4. The dual head ratchet and socket wrench assembly of claim 1, wherein the male connector provided on the right end of the second elongated shaft is a ratchet extending out from the L-shaped rigid housing.

5. The dual head ratchet and socket wrench assembly of claim 1, wherein the male connector is configured to detachably receive a plurality of external mechanical tools, mechanical tool extensions and sockets.

6. The dual head ratchet and socket wrench assembly of claim 1, wherein the L-shaped rigid housing is formed by connecting a pair of hollow rigid tubes at a right angle.

7. The dual head ratchet and socket wrench assembly of claim 1, wherein the L-shaped rigid housing is formed from rigid materials including metals, alloys, plastic, rubber and a combination thereof.

8. The dual head ratchet and socket wrench assembly of claim 1, wherein the pair of gears includes a first gear attached to the bottom end of the first elongated shaft and a second gear attached to the left end of the second elongated shaft.

9. The dual head ratchet and socket wrench assembly of claim 1, wherein the pair of gears enables the rotation of the first elongated shaft and the second elongated shaft within the L-shaped rigid housing.

10. The dual head ratchet and socket wrench assembly of claim 1, wherein the L-shaped rigid housing enables the socket provided on the top end of the first elongated shaft and the ratchet provided on the right end of the second elongated shaft to reach into a plurality of narrow corners.
